(19) United States
(12) Patent Application Publication
(10) Pub. No.: US 2026/0099393 A1
(43) Pub. Date: Apr. 9, 2026

(54) HISTORY MANAGEMENT SYSTEM, HISTORY MANAGEMENT METHOD, AND PROGRAM

(71) Applicant: Definer Inc., Tokyo (JP)

(72) Inventor: Kentaro SAKAMOTO, Tokyo (JP)

(21) Appl. No.: 19/179,339

(22) Filed: Apr. 15, 2025

(30) Foreign Application Priority Data
Oct. 7, 2024 (JP) 2024-176180

(51) Int. Cl. G06F 9/54

(52) U.S. Cl. CPC G06F 9/542

(57) ABSTRACT

A history management system includes: a storage unit configured to store a credential of a plurality of web tools that are used by a user, in association with user information; an acquisition unit configured to acquire event history information from a tool of the user from a plurality of tools, on a basis of the credential associated with the user information; and a display processing unit configured to cause a history to be displayed on a basis of the acquired event history information, in which the event history information is information regarding a history of an event including an active event caused by work of the user.

### BACKGROUND

### Technical Field

The present invention relates to a history management system, a history management method, and a program.

### Related Art

In recent years, workers have increasingly performed their business assignment by using software tools. In such a case, it is difficult for an employer or the like who manages the workers to grasp a labor situation, productivity, and the like of the workers. Therefore, a technique for grasping a worker's labor situation has been developed.

For example, JP 2022-134079 A discloses a labor management system for collecting log information from a peripheral system and the like to enable grasping and tracking of a worker to be cared for.

### SUMMARY

However, the invention described in JP 2022-134079 A does not disclose any specific method for acquiring event history information from a web tool and displaying the event history information.

Therefore, an object of the present invention is to provide a history management system for acquiring a history of a web tool used by an individual user and showing a business assignment situation of the user.
[1] A history management system including:
a storage unit configured to store a credential of a plurality of web tools that are used by a user, in association with user information;
an acquisition unit configured to acquire event history information from a tool of the user from a plurality of tools, on the basis of the credential associated with the user information; and
a display processing unit configured to cause a history to be displayed on the basis of the acquired event history information, in which
the event history information is information regarding a history of an event including an active event caused by work of the user.
[2] The history management system according to [1], in which
the event history information includes an event content and date and time information,
the display processing unit displays, in chronological order, two or more event display elements that are display elements of a screen related to an event, on the basis of the event history information, and
the event display elements are elements of screen display indicating an event content and an occurrence date and time of an event.
[3] The history management system according to [2], in which
the display processing unit displays, in chronological order, a first event display element indicating occurrence of a first event and a second event display element indicating occurrence of a second event, and displays a time difference between occurrence of the first event and occurrence of the second event.
[4] The history management system according to [2], further including
a specification processing unit, in which
upon receiving a specification condition including a required time, the specification processing unit specifies a history of an event in which a time difference until next event occurrence corresponds to the specification condition, on the basis of the event history information including the date and time information, and
the display processing unit displays the event display elements based on event history information corresponding to the specification condition.
[5] The history management system according to [2], in which
the event history information includes access information for an event target display screen in a web tool, and
each of the event display elements includes an access element for the event target display screen based on the access information.
[6] The history management system according to [2], further including
a status specification unit, in which
the event history information includes: event target identification information for specifying a target of an event; and an event type,
the status specification unit specifies a status related to an event target on the basis of the event target identification information and the event type, and
each of the event display elements displays the status.
[7] The history management system according to [6], in which
the web tools include a message tool, and
the status specification unit specifies a status related to a conversation, the status including being replied and being unreplied, on the basis of the event history information including: the event type including reception and transmission; and the event target identification information.
[8] The history management system according to any one of [1] to [7], in which
the event history information is information including a history of occurrence of an event caused by the user performing work with a web tool, and the event history information includes date and time information and an event type for identifying at least a passive event and an active event, and
the display processing unit causes an activity history of the user to be displayed on the basis of the event history information regarding an active event specified on the basis of the event type.
[9] The history management system according to [8], further including
an activity time specification unit and a specification processing unit, in which
the activity time specification unit specifies an activity start time and an activity end time of one day on the basis of the event history information,
the acquisition unit acquires a reported working start time and a reported working end time of a user,
the specification processing unit receives a work specification condition including an allowable time, and specifies a working day of a user in which a difference between the activity start time and the reported working start time and/or a difference between the reported working end time and the activity end time is equal to or longer than the allowable time, and
the display processing unit displays a list of: a date on a working day of a user specified by the specification processing unit; the activity start time; and the activity end time.
[10] The history management system according to [8], further including
an index calculation unit, in which
the index calculation unit calculates an activity index related to an activity history of the user, on the basis of the event history information regarding an active event, and
the display processing unit causes the activity index to be displayed.
[11] The history management system according to [10], in which
the event history information includes date and time information, and
the activity index includes an activity amount indicating a total amount of an activity history of a user per unit time based on the event history information.
[12] The history management system according to [11], in which
the event history information includes a tool type, and
the display processing unit causes an activity amount to be displayed for each tool type.
[13] The history management system according to [10], in which
the event history information includes identification information that is unique and is for specifying a related event, and
the activity index includes a required time from occurrence of a first event to occurrence of a second event that is specified on the basis of the identification information and related to the first event.
[14] The history management system according to [10], in which
the user information includes department information,
the index calculation unit calculates the activity index for each department, and
the display processing unit causes the activity index for each department to be displayed.
[15] The history management system according to [10], further including
a specification processing unit, in which
the specification processing unit receives a specification condition, and specifies event history information corresponding to the specification condition on the basis of the event history information, and
the index calculation unit calculates the activity index on the basis of event history information corresponding to the specification condition specified by the specification processing unit.
[16] A history management method executed by a computer,
in which a storage unit of the computer stores a credential of a plurality of web tools that are used by a user, in association with user information,
the history management method including:
an acquisition step of acquiring event history information from a tool of the user from a plurality of tools, on the basis of the credential associated with the user information; and
a display processing step of displaying a history on the basis of the acquired event history information, in which
the event history information is information regarding a history of an event including an active event caused by work of the user.
[17] A computer program causing the computer to execute the history management method according to [16].

With the invention according to [1], the event history information can be collected using the credential also for the web tool, and the history can be displayed.

With the invention according to [2], it is possible to display a history of an event in chronological order.

With the invention according to [3], it is possible to check a difference in time at which an event occurs.

With the invention according to [4], it is possible to specify and display a history corresponding to a specification condition in which a time difference is equal to or longer than a required time set as a condition.

With the invention according to [5], it is possible to easily transition from a screen displaying a history to a screen displaying a target of the event, and display the screen.

With the invention according to [6], it is possible to specify and display a status of a target of the event.

With the invention according to [7], it is possible to specify and display a status such as being replied or being unreplied, regarding a message tool such as a mail application.

With the invention according to [8], it is possible to display an activity history of a user by using event history information regarding occurrence of an active event caused by work or the like of the user.

With the invention according to [9], it is possible to specify a working day with a high possibility of a problem that a difference between an activity time acquired from the tool and a working time reported by the user is equal to or longer than an allowable time.

With the invention according to [10], it is possible to calculate and display an activity index of the user by using event history information regarding an active event caused by the activity of the user.

With the invention according to [11], it is possible to display a situation of an activity by using the tool of the user per unit time.

With the invention according to [12], it is possible to display a situation of an activity for each tool type.

With the invention according to [13], it is possible to specify and display a required time from occurrence of a certain event to occurrence of a next event, for a target event.

With the invention according to [14], it is possible to display an activity index of the user for each department.

With the invention according to [15], it is possible to calculate and display an activity index by using event history information corresponding to a condition.

### BRIEF DESCRIPTION OF DRAWINGS

FIG. 1 is a block diagram illustrating a configuration of an entire system;

FIGS. 2A and 2B are hardware configuration diagrams of the system;

FIGS. 3A and 3B are data configuration diagrams according to an embodiment;

FIG. 4 is a screen display example according to the embodiment;

FIG. 5 is a screen display example according to the embodiment;

FIG. 6 is a screen display example according to the embodiment; and

FIG. 7 is a screen display example according to the embodiment.

### DETAILED DESCRIPTION

Hereinafter, the present invention will be described in more detail with reference to the accompanying drawings. A preferred embodiment is shown in the drawings. However, the present invention can be implemented in many different forms and is not limited to the embodiment described herein.

For example, in the present embodiment, a configuration, an operation, and the like of a history management system will be described, but similar operational effects can also be obtained by a method, a device, a computer program, and the like to be executed. The program may be provided as a non-transitory computer-readable recording medium or may be provided in a downloadable manner from an external server.

A history management system according to an embodiment of the present invention collects and displays event history information of a tool used by a worker for business assignment, particularly a web tool such as a web application, to visualize the event history information and make it easy to grasp a situation of the worker. In the present embodiment, the event history information is used for various purposes such as performance management and attendance management as described later. In addition, the tool from which the history management system according to the present invention acquires the event history information is a web tool such as a web application used by the user for business assignment or the like. In the present embodiment, the tool is a message tool such as a mail application or a chat tool, a cloud storage, a calendar application, or the like. However, the tool may be any tool as long as the tool is used on the web and used for business assignment.

In the present embodiment, the history management system executes processing to be described later using event history information regarding an event that has occurred in a tool, such as reception and transmission of an email or a chat, creation and editing of a file in a cloud storage, and creation and editing of a schedule in a calendar application. Note that event history information collected as the event history information includes information regarding an active event caused by a user's operation such as transmission of an email or editing of a file, and regarding a passive event that occurs even if the user does not perform an operation, such as reception of an email and notification of file editing by another user. Note that, when it is desired to grasp a user's business assignment situation or activity, such as specifying a user's activity time, processing is performed using event history information regarding an active event. In the present embodiment, one piece of event history information corresponding to one event is acquired. In the present embodiment, processing to be described later is performed using a plurality of pieces of the acquired event history information.

### System Configuration

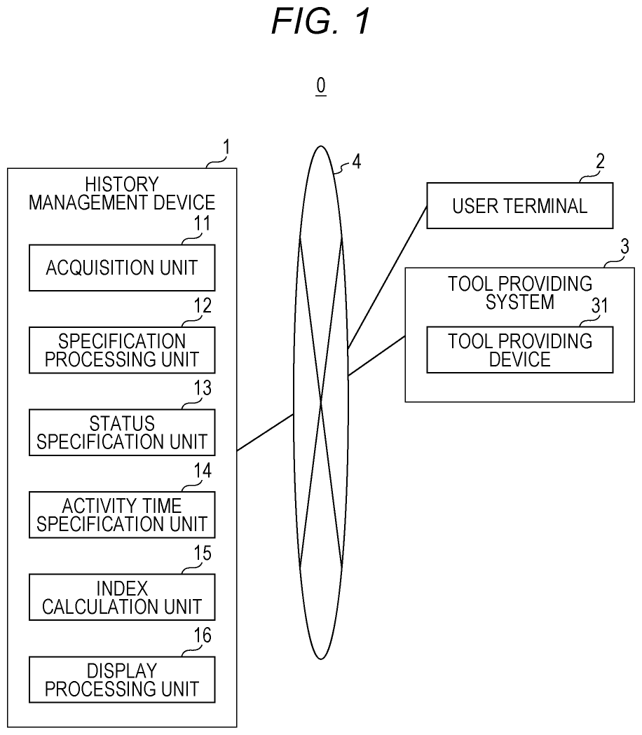

FIG. 1 is a block diagram illustrating a configuration of a system according to an embodiment. As illustrated in FIG. 1, a history management system 0 includes a history management device 1, a user terminal 2, and a tool providing system 3, which are communicably connected via a network 4.

As the history management device 1, one or a plurality of server devices such as a general-purpose server and a personal computer can be used.

As the user terminal 2, a terminal device such as a personal computer, a smartphone, or a tablet terminal can be used. The user terminal 2 is connected to the history management device 1 by executing a history management device usage program such as a browser application, and executes processing to be described later. In the present embodiment, the history management device usage program is a browser application pre-installed or downloaded in advance on the user terminal 2, but may be a client application or the like downloaded from a program providing device (not illustrated).

The tool providing system 3 includes a tool providing device 31. As the tool providing device 31, one or a plurality of server devices such as a general-purpose server and a personal computer can be used. In the present embodiment, the tool providing device 31 provides the history management device 1 with event history information regarding an event that has occurred in the tool. In addition, although not illustrated in FIG. 1, there are a plurality of tool providing systems 3. In the present embodiment, the tool providing system 3 is a system that provides functions of a web application such as a mail application, a chat tool, a cloud storage, and a calendar application. In the present embodiment, the history management device 1 acquires event history information from the tool providing system 3 via the network 4.

The network 4 is an Internet protocol (IP) network, but the type of communication protocol, the type of network, and the like are not limited.

### Hardware Configuration

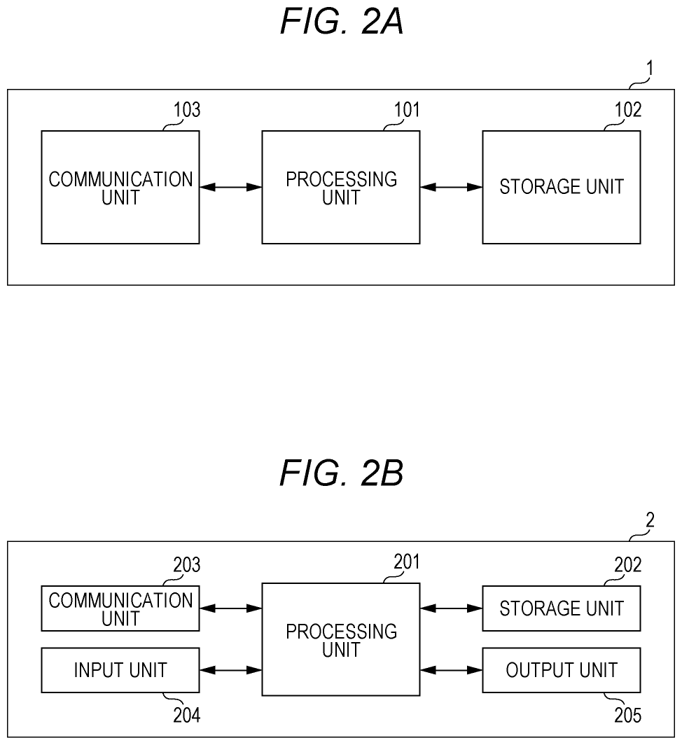

FIGS. 2A and 2B are hardware configuration diagrams of the history management device 1 and the user terminal 2.

FIG. 2A is a hardware configuration diagram of the history management device 1. As illustrated in FIG. 2A, the history management device 1 includes a processing unit 101, a storage unit 102, and a communication unit 103, and is used for exerting action of each unit and each step.

The processing unit 101 includes a processor such as a CPU capable of executing a command set, and executes an OS, a history management program, and the like.

The storage unit 102 includes a volatile memory such as a RAM capable of storing a command set, and a nonvolatile recording medium such as an HDD or an SSD capable of recording an OS, a history management program, and the like.

The communication unit 103 has an interface for connecting to the network 4, and executes communication control between with the network 4 to input and output information.

FIG. 2B is a hardware configuration diagram of the user terminal 2. As illustrated in FIG. 2B, the user terminal 2 includes a processing unit 201, a storage unit 202, a communication unit 203, an input unit 204, and an output unit 205, and is used for exerting action of each unit and each step.

The processing unit 201 includes a processor such as a CPU capable of executing a command set, and executes programs such as an OS and a history management device usage program.

The storage unit 202 includes a volatile memory such as a RAM capable of storing a command set, and a nonvolatile recording medium such as an HDD or an SSD capable of recording an OS and an application program (a history management device usage program or the like) capable of using a plurality of services including a history management service.

The communication unit 203 has an interface for connecting to the network 4, and executes communication control between with the network 4 to input and output information.

The input unit 204 includes an input device such as an operation input device capable of performing input processing, such as a touch panel or a keyboard.

The output unit 205 includes an output device such as a display device capable of performing display processing.

### Data Configuration

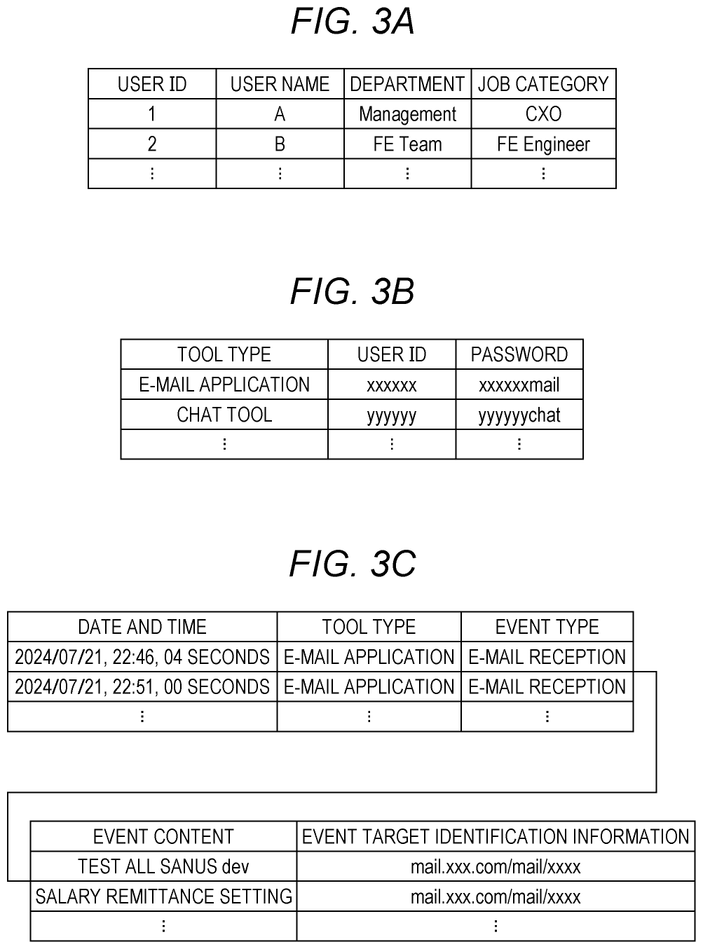

Hereinafter, with reference to FIGS. 3A and 3B, a description will be made on an example of a data configuration of various data stored in the storage unit 102 and used for processing to be described later in the history management system 0. The storage unit 102 stores user information regarding a user, a credential of a web tool, and event history information acquired from the plurality of tool providing systems 3.

The user information illustrated in FIG. 3A is information regarding a user in the history management system 0, and includes identification information (user ID or the like), a user name, and department information regarding a department to which the user belongs. In addition, one or a plurality of credentials are registered in the user information in association with the identification information such as the user ID.

The credential illustrated in FIG. 3B is information for authenticating the user in the tool providing system 3, and includes a tool type (tool name), user identification information such as a user ID, and a password. In the present embodiment, the credential includes a password, but the credential may not include a password or may be information in any format such as an e-mail address, as long as the user can be authenticated. In the present embodiment, in a case where the user uses a plurality of web tools, a plurality of credentials having different tool types are associated with the user information. Note that, in a case where the user has a plurality of accounts in a specific tool, a plurality of credentials (with the same tool type) related to the same tool may be associated with one piece of user information. The history management system 0 acquires event history information of a user of another tool providing system 3 specified by the credential, as information regarding a history of a tool of a user of the history management system having user information associated with the credential used for the acquisition.

The event history information illustrated in FIG. 3C is information regarding a history of an event in the tool, and includes date and time information, a tool type, an event type, an event content, event target identification information, and access information. In the present embodiment, the event history information is stored in association with user information of a user associated with the credential information used at the time of acquisition.

The date and time information is information regarding an occurrence date and time of the event. In addition, in the present embodiment, the date and time information includes information regarding date, time, and day of the week.

The tool type is a type of a tool as an acquisition source from which the event information is acquired, and includes a mail application, a chat tool, a cloud storage, an online meeting tool, and the like in the present embodiment. Note that, as the tool types, Mail application A and Mail application B may be identified as different tool types.

The event type is a type of an event. In the present embodiment, an event type suitable for each tool type is set, such as e-mail reception or e-mail transmission when the tool type is mail application, and file creation or file editing when the tool type is cloud storage. Note that, in the present embodiment, the event history information is classified into event history information regarding an active event and event history information regarding a passive event on the basis of the event type. For example, event history information whose event type is e-mail reception is classified into the event history information regarding a passive event, and event history information whose event type is e-mail transmission is classified into the event history information regarding an active event. In the present embodiment, the event type is classified into either an active event or a passive event, but there may be an event type classified into another classification.

The event content information is information regarding a content of an event. In the present embodiment, the event content information indicates a name of a target of the event such as a subject of an e-mail when the tool type is e-mail, and a file name when the tool type is cloud storage. However, the event content information may be a body of an e-mail as long as the information is related to a content of the event.

The event target identification information is unique identification information for identifying a target of an event. In the present embodiment, the event target identification information is a unique uniform resource locator (URL) for identifying a group of event history information regarding an event that has occurred on the same target, such as a channel or a thread of a chat tool, an event such as creation or editing of a file in a cloud storage, and transmission and reception of an e-mail displayed on one screen as thread display in a mail application. However, the event target identification information may have any format such as a name of the event target, as long as the information can be used to identify the target of the event that has occurred. Note that the target of an event is a target on which the event occurs in the tool, and includes an e-mail, a thread, a file, and the like in the present embodiment. Furthermore, in the present embodiment, the event target identification information is a URL that allows transition to a screen for displaying the event target, and thus also functions as access information to be described later.

The access information is information that allows transition to the event target display screen displayed for the target of the event in the web tool, and is a URL in the present embodiment. Note that the event target display screen is a screen for displaying an event target, and is, for example, an e-mail display screen in a mail application, a channel or thread display screen in a chat tool, a file display screen in a cloud storage, or the like.

Note that, in the present embodiment, the history management system 0 executes processing to be described later using processed event history information subjected to preprocessing of converting into a form easy to handle in the system. However, processing to be described later may be executed using raw data acquired from the tool providing system 3.

### Functional Configuration of History Management System 0

FIG. 1 further illustrates a functional configuration of the history management system 0. As illustrated in FIG. 1, the history management device 1 includes an acquisition unit 11, the specification processing unit 12, the status specification unit 13, the activity time specification unit 14, the index calculation unit 15, and the display processing unit 16. This functional configuration is obtained when processing by software (a history management program temporarily or non-temporarily stored in the storage unit 102) is specifically implemented by hardware (the processing unit 101 or the like). In addition, the user terminal 2 may include a part of the functional configuration to be described later, and execute a part of the processing. At this time, the user terminal 2 stores a part of the history management program in the storage unit 202, and executes the part of the processing of the history management device 1 by executing the part of the history management program in the processing unit 201.

### Acquisition Unit 11

The acquisition unit 11 acquires event history information from one or a plurality of tool providing systems 3 on the basis of a credential associated with user information, and stores the event history information in the storage unit 102. In the present embodiment, the acquisition unit 11 acquires event history information regarding an event that has occurred in a web tool of a specific user, by using the credential associated with the user information. Note that the acquired event history information is stored in the storage unit 102 in association with the user information associated with the credential used for the acquisition, and is used for processing to be described later as a history of an event in the tool of the specific user. Furthermore, the acquisition unit 11 may be configured to perform processing of periodically acquiring data from the tool providing system 3, or may be configured to acquire data when an event occurs in the tool providing system 3.

In addition, the acquisition unit 11 may perform processing of converting raw data of event history information acquired from the tool providing system 3 into a format that can be easily used in the history management system 0. At this time, the acquisition unit 11 performs conversion into a format suitable for use in the history management system 0, on the basis of a conversion rule for each tool type stored in the storage unit 102.

In addition, the acquisition unit 11 receives various inputs from the user terminal 2, such as a specification condition, a work specification condition, a reported working start time, a reported working end time, a specification condition, and a work specification condition. In addition, the acquisition unit 11 may receive the user information from the user terminal 2.

### Specification Processing Unit 12

The specification processing unit 12 specifies event history information corresponding to a condition on the basis of a specification condition received from the user terminal 2. The specification condition is a condition for specifying event history information desired to be extracted and set by the user, and includes a start date, an end date, a start time, an end time, a tool type, a keyword, an event type, a required time, a user, and a department of the user in the present embodiment. Note that, when the start date is specified, the specification processing unit 12 specifies event history information regarding an event that has occurred on or after the start date, as the event history information corresponding to the condition. When the end date is specified, the specification processing unit 12 specifies event history information regarding an event that has occurred on or before the end date, as the event history information corresponding to the condition. Further, the specification processing unit 12 specifies event history information of a designated user or a user belonging to a designated department under the specification condition.

In addition, the specification processing unit 12 specifies a working day of a user corresponding to a condition on the basis of a work specification condition received from the user terminal 2. The work specification condition is a condition for specifying work to be grasped, and includes an allowable time, a department, a start date, and an end date in the present embodiment. When the start date is set in the work specification condition, a working day on or after the set date is specified. When the end date is set, a working day before the set date is specified as a date corresponding to the work specification condition. In the present embodiment, on the basis of the work specification condition including the allowable time, the reported working start time and the reported working end time acquired by the acquisition unit 11, and an activity start time and an activity end time specified by the activity time specification unit 14, the specification processing unit 12 specifies a working day of a user in which one or both of a difference between the activity start time and the reported working start time (a difference obtained by subtracting the reported working start time from the activity start time) and a difference between the reported working end time and the activity end time (a difference obtained by subtracting the activity end time from the reported working end time) is equal to or longer than the allowable time. In addition, the specification processing unit 12 may specify a working day on which a difference between the activity time and the work time (for example, a time from the reported working start time to the reported working end time) of the user in one day is equal to or longer than the allowable time.

Work having a difference between the reported time and the activity time is likely to be problematic work. By performing such processing in the specification processing unit 12, it is possible to specify a working day on which there is a possibility of a problem that there is a difference between working hours and the actual operating hours.

### Status Specification Unit 13

The status specification unit 13 specifies a status related to a specific event target, on the basis of event history information including event target identification information and an event type.

Hereinafter, a description will be given regarding a specific example of a status of a message tool such as a mail application, in a case where the storage unit 102 stores event history information at the time when a certain user receives E-mail MA, event history information at the time when E-mail MB as a reply to E-mail MA is transmitted, and event history information regarding E-mail MC not related to E-mail MA and E-mail MB. Note that, in the mail application, a series of related e-mails (for example, E-mail MA and E-mail MB) displayed on one screen in thread display is managed in association with unique identification information in the tool providing system 3, and event history information regarding the series of e-mails is stored in the storage unit 102 in association with unique event target identification information. At this time, the event type of E-mail MA and E-mail MC is e-mail reception, and the event type of E-mail MB is e-mail transmission.

Since events such as reception of an e-mail and transmission of an e-mail have occurred for the series of E-mails MA and MB, the status specification unit 13 specifies the status as being replied. For E-mail MC, an event whose type is e-mail reception has occurred, but an event of e-mail transmission is not associated with event history information associated with the same event target identification information. Therefore, the status specification unit 13 specifies the status as unreplied e-mail. As described above, in the present embodiment, in a case where the tool type is e-mail, the status specification unit 13 specifies a status including being unreplied or replied e-mail for the event target e-mail on the basis of the event type and the event target identification information. In addition, in the present embodiment, as a status in a message tool including a mail application, the status of being replied or unreplied is specified as a status related to a series of conversations to be transmitted or replied, and displayed as a thread.

Here, a status of an e-mail and the like has been described. However, the status specification unit 13 may specify any status as long as the status of the event target can be specified on the basis of event history information regarding an event continuously occurring for the event target. For example, the status specification unit 13 may specify a status of being updated or non-updated file in a cloud storage, being answered or non-answered on whether or not to participate in an invitation of a schedule in a calendar application, or the like.

In addition, the status specification unit 13 may further specify the status in consideration of a context of occurrence of the event on the basis of date and time information, such as specifying the status as being replied when an event of e-mail transmission occurs after an event whose event type is e-mail reception in the event history information, in event history information associated with the same event target identification information.

### Activity Time Specification Unit 14

The activity time specification unit 14 specifies an activity start time and an activity end time in one day on the basis of event history information. Note that, in order to specify an activity time of a target user, the activity time specification unit 14 specifies an activity start time, an activity end time, and an activity time using event history information regarding an active event caused by an activity of the user, excluding event history information regarding a passive event such as e-mail reception. The activity time specification unit 14 specifies event history information regarding an active event on the basis of the event type included in the event history information, and performs processing related to specifying the activity start time, the activity end time, and the activity time for each working day using the specified event history information regarding an active event. In the present embodiment, the activity time specification unit 14 specifies a time at which the first active event has occurred in one day as the activity start time and a time at which the last active event has occurred in one day as the activity end time, on the basis of event history information associated with user information of a specific user. Alternatively, as the activity start time or the activity end time, the activity time specification unit 14 may specify a time at which a certain condition is satisfied on the basis of the event history information, such as specifying, as the activity start time or the activity end time, a time at which the first or last event has occurred a predetermined number of times or more or a predetermined number of times or less in one day, or a time at which the first or last event has occurred a predetermined number of times or more per unit time or a predetermined number of times or less in one day.

Furthermore, the activity time specification unit 14 further specifies an activity time that is a time during which the user performs an activity such as business assignment by using a tool. In the present embodiment, the activity time specification unit 14 specifies a time from the activity start time to the activity end time as the activity time. However, the activity time may be specified by using any method as long as the time during which the user is active can be specified on the basis of the event history information, such as specifying, as a time of being active, the activity time by counting a time period during which there is event history information regarding a certain number or more of active events per unit time. The activity start time, the activity end time, and the activity time for each working day specified by the activity time specification unit 14 may be stored in the storage unit 102 in association with the user information for each working day, and may be used for display processing of an attendance management screen or processing related to specification of a working day corresponding to a condition in the specification processing unit 12. Furthermore, the activity time specification unit 14 may specify a time during which the user is active using a tool for each tool type.

### Index Calculation Unit 15

The index calculation unit 15 calculates an activity index on the basis of event history information. The activity index is an index of an activity of a user based on the event history information. In the present embodiment, the activity index includes an activity amount, the number of e-mails transmitted, the number of e-mails unreplied, a message reply time, and a required time. Furthermore, the index calculation unit 15 may calculate the activity index for the user on the basis of event history information associated with user information, or may calculate the activity index in a group of a plurality of users on the basis of event history information of a plurality of users such as users belonging to a specific department. In addition, on the basis of a specification condition received from the user terminal 2, the index calculation unit 15 may calculate an index by using event history information corresponding to a specification condition specified by the specification processing unit 12, for example, by calculating the activity index by using event histories of a plurality of users belonging to a specific department.

Specific examples of the activity index will be described below. The activity amount is an amount of occurrence of active events per unit time, and is the number of pieces of history information regarding active events, in the present embodiment. In the present embodiment, the index calculation unit 15 calculates, as a total activity amount, the number of pieces of event history information regarding active events in a case where the unit time is one week, and calculates an average of the total activity amount per unit time (in the present embodiment, the unit time is one day: total activity amount÷7 days) as an average activity amount. In addition, the index calculation unit 15 may calculate the number of pieces of history information for each tool type and each event type as the activity index. In the present embodiment, the index calculation unit 15 calculates, as the activity index, the number of e-mails transmitted whose tool type is e-mail and event type is e-mail transmission. In addition, the index calculation unit 15 may calculate the number of event targets of a specific status such as the number of e-mails unreplied and the number of e-mails replied as the activity amount, on the basis of the status specified by the status specification unit 13.

The required time is a time from occurrence of a certain event (first event) to occurrence of the next event (second event). In the present embodiment, the index calculation unit 15 calculates the required time on the basis of event history information corresponding to a specification condition acquired from the user terminal 2, such as a required time from occurrence of a passive event such as reception of an e-mail to occurrence of an active event such as reply of an e-mail, or a time required until the next event occurs in a specific tool. The average required time is an average of required times of a specific user in a unit time period, and is an average of required times of the specific user in one week in the present embodiment.

In addition, the index calculation unit 15 may calculate the average required time for each tool type. In the present embodiment, the index calculation unit 15 calculates an average response time which is an average required time related to a message tool, on the basis of event history information whose tool type is message tool. At this time, the index calculation unit 15 uses the event history information associated by the event target identification information to calculate, as the average required time, an average of response times per unit time, by using, as a response time, a required time from an event of reception of an e-mail or a message (event whose event type is reception) to an event of transmission of an e-mail or a message (event whose event type is transmission), for a specific event target. Note that, in the present embodiment, the average response time is an average required time for the mail application, but may be an average of required times for a plurality of tools for transmitting and receiving messages such as a chat tool and a mail application.

Furthermore, the response speed is a speed corresponding to an event, and is an index calculated by dividing a unit time by the number of times of occurrence of active events (the number of pieces of event history information regarding active events) in the present embodiment. However, the response speed may be an index calculated by any method as long as the speed is calculated on the basis of the event history information, such as a reciprocal of a time from occurrence of a passive event such as notification of an email to occurrence of an active event such as transmission of an email.

### Display Processing Unit 16

The display processing unit 16 performs processing related to display processing of various screens such as a history display screen, an attendance management screen, and a dashboard screen on the basis of event history information.

### Description of Screen Display Example

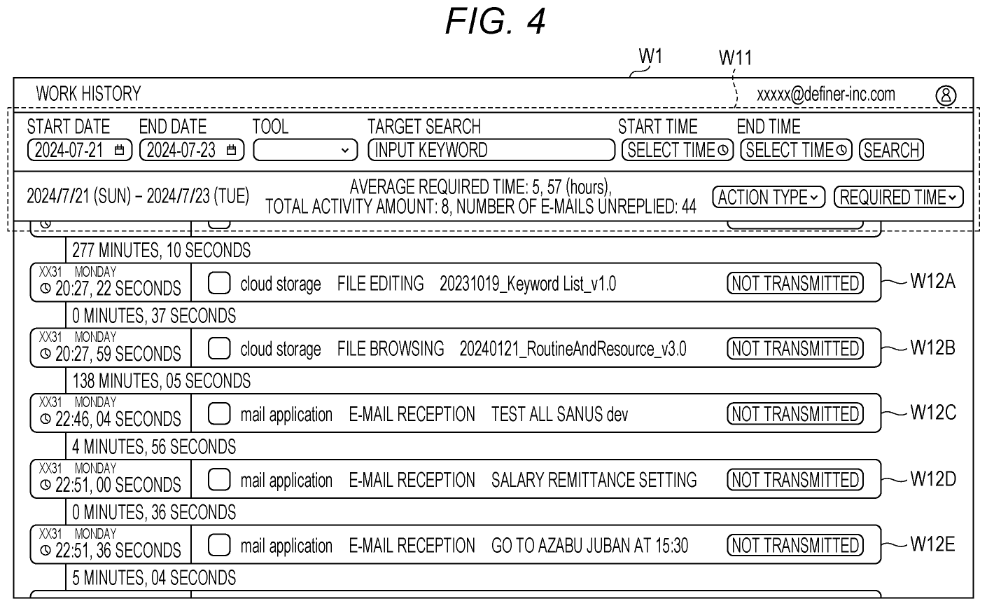

Hereinafter, with reference to FIGS. 4 to 7, an example of a screen display example displayed by the display processing unit 16 will be described.

### History Display Screen

FIG. 4 is a screen display example of a history display screen displayed by the display processing unit 16. A history display screen W1 is a screen for displaying a history of an event displayed on the basis of event history information, and includes a specification condition input element W11 and event display elements W12A to W12E. In the example illustrated in FIG. 4, five event display elements are displayed, but the number of event display elements is not limited, and may be five or more or five or less.

The specification condition input element W11 is a screen display element for inputting a condition (specification condition) for specifying the event history information. In the present embodiment, the specification condition input element W11 is a screen display element that allows inputting of a condition regarding a start date, an end date, a tool type, a keyword, a start time, an end time, an action type (event type), and a required time.

The event display elements W12A to W12E are screen display elements for displaying a history of events (Events EA to EE) displayed on the basis of the event history information. In the present embodiment, the event display elements W12A to W12E are rectangular regions for displaying an occurrence date and time of an event based on date and time information, an event type, an event content, and a status of an event target related to the event. In addition, the event content functions as an access element (link) that allows transition to an event target display screen when pressed, on the basis of access information. In the present embodiment, when the access element is pressed, the user terminal 2 displays the event target display screen in another tab of a browser application.

Note that, in the example illustrated in FIG. 4, the event display elements W12A to W12E corresponding to Events EA to EE are displayed. In addition, the event display elements W12A to W12E are connected and displayed in the order of occurrence date and time of the event (chronological order), and a difference (required time) between occurrence dates and times of the events in the individual event display elements is displayed between the event display elements, such as a difference (4 minutes and 56 seconds) in time from reception of an e-mail with the title “Test all SANUS dev” (Event EC) to reception of an e-mail with the title “Salary remittance setting” (Event ED) between the event display element W12C (first event display element) and the event display element W12D (second event display element).

When a specification condition is input and a search button is pressed in the specification condition input element W11, the specification processing unit 12 specifies event history information corresponding to the specification condition. The display processing unit 16 causes display of an event display element based on the event history information corresponding to the specification condition specified by the specification processing unit 12, and does not cause display of event history information not corresponding to the specification condition. At this time, the difference in time displayed between the event display elements is a difference in time between the events displayed on the screen, but may be a difference from an event occurrence date and time in event history information that does not correspond to the specification condition and is not displayed on the screen.

### Attendance Management Screen

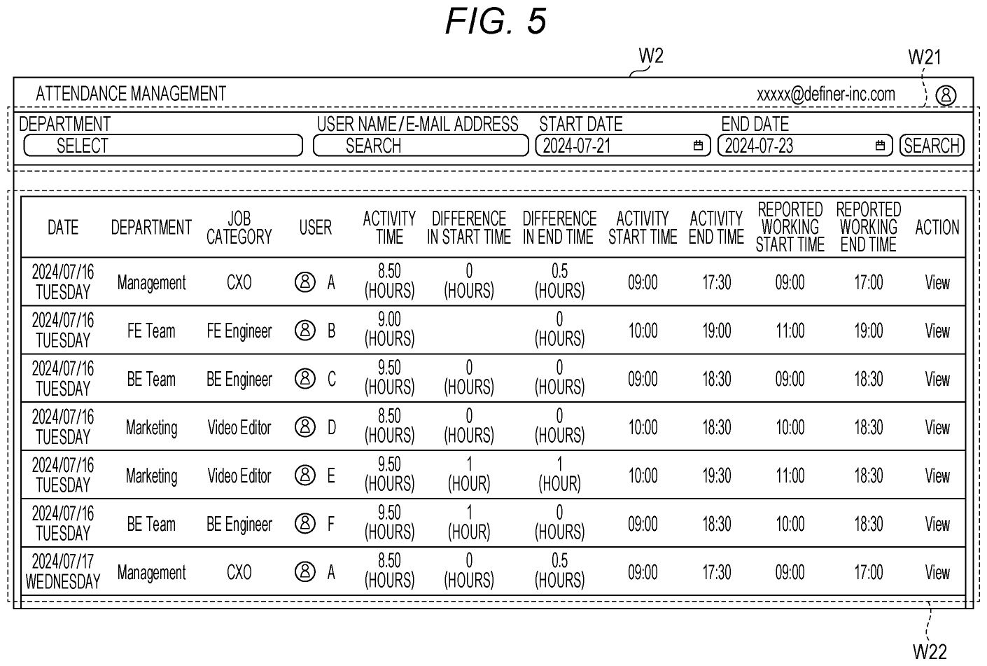

An attendance management screen W2 illustrated in FIG. 5 is a screen displayed by the display processing unit 16 for displaying a list of work situations of a user, and includes a work specification condition input element W21 and a work list W22. In the present embodiment, for displaying the attendance management screen W2, processing related to specifying an activity start time, an activity end time, and an activity time for each working day in the activity time specification unit 14 is performed in advance.

The work specification condition input element W21 is a screen element for inputting a work specification condition for specifying work. In the present embodiment, the work specification condition input element W21 includes a search button and an input field for inputting a work specification condition including a department, a user name/e-mail address, a start date, and an end date. For the start date and the end date, the start date or the end date can be input by pressing a date of a calendar that is displayed by pressing a calendar icon. In the present embodiment, when a character string is input in the input field for inputting a condition regarding a user name and an e-mail address, a user including the character string as a part or all of the user name and the e-mail address is specified by the specification processing unit 12, and information regarding a working day of the user is displayed in the work list W22.

The work list W22 is a list for displaying a work situation, and displays, for each working day, a date, a department of a user, user information including a job category of the user and a user name, an activity time, a difference in start time (a difference between an activity start time and a reported working start time), a difference in end time (a difference between an activity end time and a reported working end time), an activity start time and an activity end time specified by the activity time specification unit 14, and a reported working start time and a reported working end time acquired by the acquisition unit 11.

When the work specification condition is input and the search button is pressed in the work specification condition input element W21, the specification processing unit 12 specifies a working day corresponding to the work specification condition. The display processing unit 16 causes the work list W22 to display the working day corresponding to the work specification condition specified by the specification processing unit 12.

### Dashboard Screen

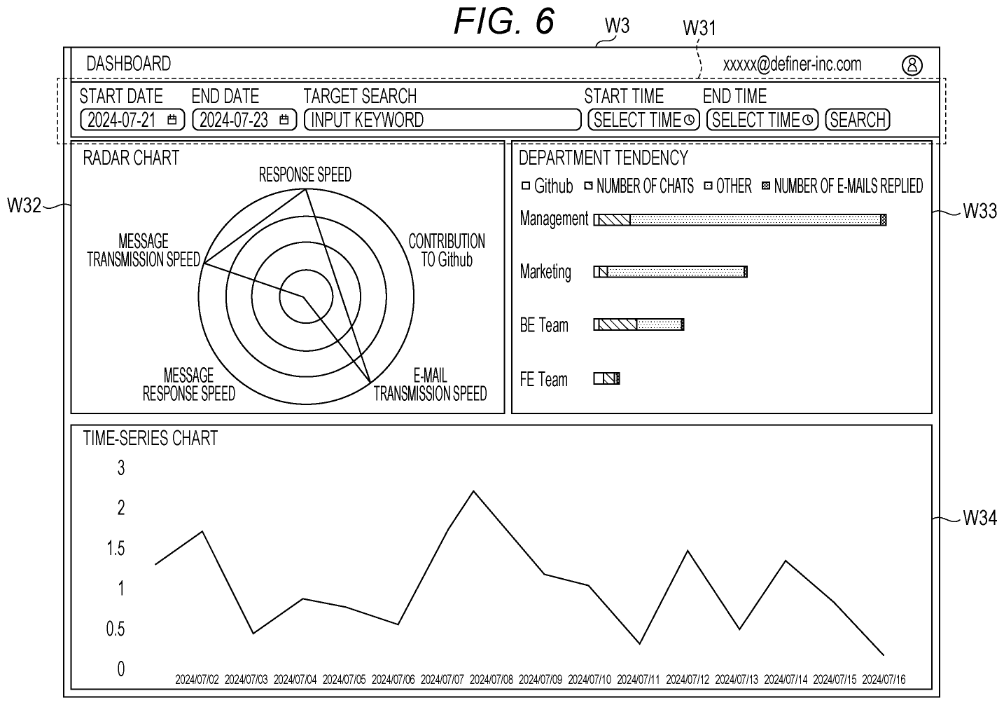

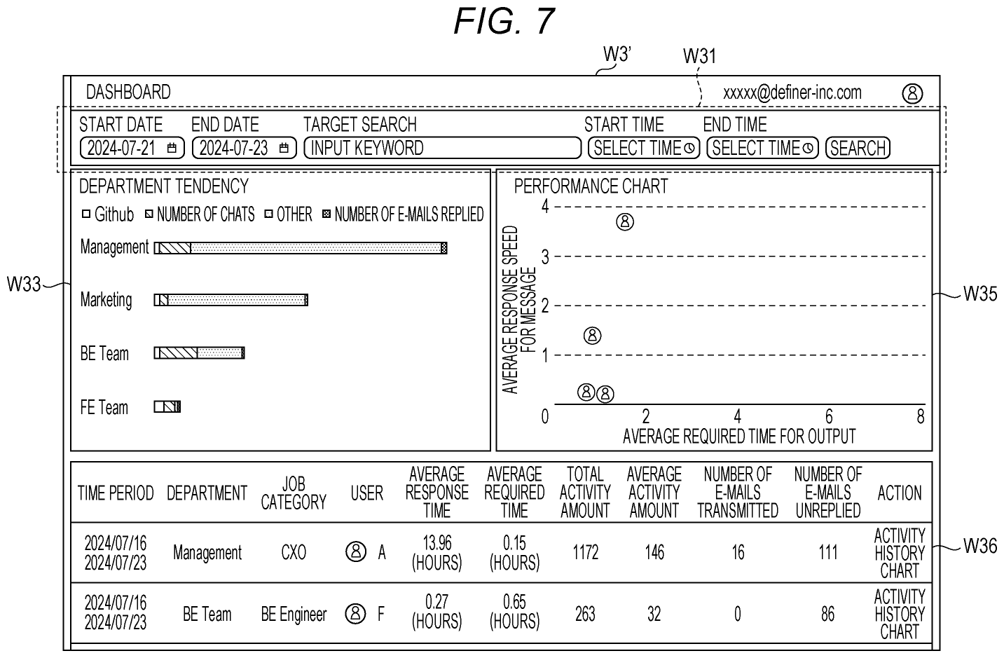

With reference to FIGS. 6 and 7, a screen display example of a dashboard screen displayed by the display processing unit 16 on the basis of an activity index calculated by the index calculation unit 15 will be described. The dashboard screen is a screen for displaying a graph and a table based on the activity index calculated by the index calculation unit 15. Note that a dashboard screen W3 in FIG. 6 is a screen displayed on the user terminal 2 of an operator or the like to display an activity index of a specific user, and a dashboard screen W3′ illustrated in FIG. 7 is a screen displayed on the user terminal 2 of an administrator or the like to enable checking of detailed activity indexes of a plurality of users. Note that the display of the screen in FIGS. 6 and 7 is merely an example, and for example, a graph, a list, or the like using an activity index different from the example illustrated in the figure may be displayed.

The dashboard screen W3 in FIG. 6 includes a condition input element W31, a radar chart display region W32, a department tendency display region W33, and a time-series chart display region W34.

The condition input element W31 is a screen element for inputting a condition (specification condition) for specifying event history information to be used for display of the dashboard. In the present embodiment, the condition input element W31 includes a search button and an input element for inputting various conditions including a start date, an end date, a keyword, and a start time. When the condition is input in the condition input element W31 and then the search button is pressed, the specification processing unit 12 specifies event history information corresponding to the specification condition input in the condition input element W31, and the index calculation unit 15 calculates the activity index by using the event history information corresponding to the specification condition specified in the specification processing unit 12 and input in the condition input element W31. In the present embodiment, when the start date is designated, the index calculation unit 15 calculates the activity index by using event history information corresponding to the condition input in the condition input element W31, such as calculating the activity index by using event history information regarding an event that has occurred on or after the start date. When the search button is pressed, the display processing unit 16 causes display of the dashboard screen W3 based on the activity index calculated by the index calculation unit 15, by using event history information corresponding to the condition input by the condition input element W31.

The radar chart display region W32 is a region for displaying a radar chart indicating a plurality of activity indexes. In the example illustrated in FIG. 6, the radar chart displayed in the radar chart display region W32 is a graph of activity indexes including a response speed (1÷response time), a message transmission speed (1÷message response time), an e-mail transmission speed (1÷e-mail response time), and contribution to Github (the number of beneficial activities (event history information of a specific event type) in event history information whose tool type is Github). The contribution to Github in the present embodiment is the number of pieces of event history information of an event type that can be determined to be useful activities as developer's activities, such as merging of pull requests, among event histories whose tool type is Github. In this manner, the index calculation unit 15 calculates the number of specific events related to a specific tool as the activity index on the basis of the tool type and the event type. The index calculation unit 15 may calculate the activity index on the basis of a status of an event specified by the status specification unit.

The department tendency display region W33 is a display region for displaying an activity amount for each department. In the example illustrated in FIG. 6, a bar graph of the activity amount is displayed for each department. The bar graph displays the activity amount (the number of pieces of event history information regarding active events) for each tool type. The department tendency display region W33 in the present embodiment illustrates a bar graph regarding the number of pieces of event history information whose tool type is Github, chat tool, or e-mail. In the example illustrated in FIG. 6, the number of pieces of event history information of a specific event type (for example, the number of pieces of event history information whose event type is transmission of chat) is displayed as the activity index for each tool type. Furthermore, in the example illustrated in FIG. 6, the number of e-mails replied is illustrated as the activity amount in the graph indicating the activity amount, but a graph indicating the number of e-mails transmitted (the number of pieces of event history information whose tool type is mail application and event type is e-mail transmission) may be displayed.

The time-series chart display region W34 is a region for displaying a graph for displaying an activity amount for each time series. In the example illustrated in FIG. 6, the graph displayed in the time-series chart display region W34 is a line graph indicating a daily activity amount.

The dashboard screen W3 illustrated in FIG. 6 is a screen for displaying an activity index of a specific user, but may be a screen for displaying an activity index based on event history information of a plurality of users corresponding to a condition input in the condition input element W31, such as users belonging to a specific department.

The dashboard screen W3′ in FIG. 7 includes the condition input element W31, the department tendency display region W33, a performance chart display region W35, and an activity list W36.

The performance chart display region W35 is a graph for displaying a value of an activity index for each user. In the example illustrated in FIG. 6, a performance chart illustrated in the performance chart display region W35 is a graph in which an average response speed of a message (1÷average response time of a message) is set on a vertical axis and an average required time is set on a horizontal axis. In addition, an icon of each user is displayed at a position where a point is plotted on the basis of the activity index of each user, but a user name may be further displayed.

The activity list W36 is a list for displaying an activity history for each user in a specific time period, and displays the activity index calculated by the index calculation unit 15, including a time period, user information including a department, a job category, and a user name of the user, an average response time, an average required time, a total activity amount, an average activity amount, the number of e-mails transmitted, and the number of e-mails not replied.

### Reference Signs List

0 history management system
1 history management device
11 acquisition unit
12 specification processing unit
13 status specification unit
14 activity time specification unit
15 index calculation unit
16 display processing unit
101 processing unit
102 storage unit
103 communication unit
2 user terminal
3 tool providing system
31 tool providing device
4 network

What is claimed is:

1. A history management system comprising:
a storage unit configured to store a credential of a plurality of web tools that are used by a user, in association with user information;
an acquisition unit configured to acquire event history information from the web tools, on a basis of the credential associated with the user information; and
a display processing unit configured to cause a history to be displayed on a basis of the acquired event history information, wherein
the event history information is information regarding a history of an event including an active event caused by work of the user.

2. The history management system according to claim 1, wherein
the event history information includes an event content and date and time information,
the display processing unit displays, in chronological order, two or more event display elements that are display elements of a screen related to an event, on a basis of the event history information, and
the event display elements are elements of screen display indicating an event content and an occurrence date and time of an event.

3. The history management system according to claim 2, wherein
the display processing unit displays, in chronological order, a first event display element indicating occurrence of a first event and a second event display element indicating occurrence of a second event, and displays a time difference between occurrence of the first event and occurrence of the second event.

4. The history management system according to claim 2, further comprising
a specification processing unit, wherein
upon receiving a specification condition including a required time, the specification processing unit specifies a history of an event in which a time difference until next event occurrence corresponds to the specification condition, on a basis of the event history information including the date and time information, and
the display processing unit displays the event display elements based on event history information corresponding to the specification condition.

5. The history management system according to claim 2, wherein
the event history information includes access information for an event target display screen in a web tool, and
each of the event display elements includes an access element for the event target display screen based on the access information.

6. The history management system according to claim 2, further comprising
a status specification unit, wherein
the event history information includes: event target identification information for specifying a target of an event; and an event type,
the status specification unit specifies a status related to an event target on a basis of the event target identification information and the event type, and
each of the event display elements displays the status.

7. The history management system according to claim 6, wherein
the web tools include a message tool, and
the status specification unit specifies a status related to a conversation, the status including being replied and being unreplied, on a basis of the event history information including: the event type including reception and transmission; and the event target identification information.

8. The history management system according to claim 1, wherein
the event history information is information including a history of occurrence of an event caused by the user performing work with a web tool, and the event history information includes date and time information and an event type for identifying at least a passive event and an active event, and
the display processing unit causes an activity history of the user to be displayed on a basis of the event history information regarding an active event specified on a basis of the event type.

9. The history management system according to claim 8, further comprising
an activity time specification unit and a specification processing unit, wherein
the activity time specification unit specifies an activity start time and an activity end time of one day on a basis of the event history information,
the acquisition unit acquires a reported working start time and a reported working end time of a user,
the specification processing unit receives a work specification condition including an allowable time, and specifies a working day of a user in which a difference between the activity start time and the reported working start time and/or a difference between the reported working end time and the activity end time is equal to or longer than the allowable time, and
the display processing unit displays a list of: a date on a working day of a user specified by the specification processing unit; the activity start time; and the activity end time.

10. The history management system according to claim 8, further comprising
an index calculation unit, wherein
the index calculation unit calculates an activity index related to an activity history of the user, on a basis of the event history information regarding an active event, and
the display processing unit causes the activity index to be displayed.

11. The history management system according to claim 10, wherein
the event history information includes date and time information, and
the activity index includes an activity amount indicating a total amount of an activity history of a user per unit time based on the event history information.

12. The history management system according to claim 11, wherein
the event history information includes a tool type, and
the display processing unit causes an activity amount to be displayed for each tool type.

13. The history management system according to claim 10, wherein
the event history information includes identification information that is unique and is for specifying a related event, and
the activity index includes a required time from occurrence of a first event to occurrence of a second event that is specified on a basis of the identification information and related to the first event.

14. The history management system according to claim 10, wherein
the user information includes department information,
the index calculation unit calculates the activity index for each department, and
the display processing unit causes the activity index for each department to be displayed.

15. The history management system according to claim 10, further comprising
a specification processing unit, wherein
the specification processing unit receives a specification condition, and specifies event history information corresponding to the specification condition on a basis of the event history information, and
the index calculation unit calculates the activity index on a basis of event history information corresponding to the specification condition specified by the specification processing unit.

16. A history management method executed by a computer,
wherein a storage unit of the computer stores a credential of a plurality of web tools that are used by a user, in association with user information,
the history management method comprising:
an acquisition step of acquiring event history information from the web tools, on a basis of the credential associated with the user information; and
a display processing step of displaying a history on a basis of the acquired event history information, wherein
the event history information is information regarding a history of an event including an active event caused by work of the user.
